(19) United States
(12) Patent Application Publication
(10) Pub. No.: US 2011/0008100 A1
(43) Pub. Date: Jan. 13, 2011

(54) JOINT ASSEMBLY FOR A FOLDABLE FURNITURE PIECE

(75) Inventor: CHUEN-JONG TSENG, Chiayi Hsien (TW)

Correspondence Address: TROP, PRUNER & HU, P.C., 1616 S. VOSS ROAD, SUITE 750, HOUSTON, TX, 77057-2631, US

(73) Assignee: Taiwan Shin Yeh Enterprise Co., Ltd

(21) Appl. No.: 12/501,507

(22) Filed: Jul. 13, 2009

(51) Int. Cl. F16D 1/12

(52) U.S. Cl. 403/104

(57) ABSTRACT

A joint assembly includes a base unit, a pivot unit, and a latch unit. The pivot unit is coupled pivotably to the base unit, and is rotatable relative to the base unit between folded and unfolded positions. The latch unit includes a latch member coupled pivotably to the base unit, a latching groove formed in the pivot unit, and a latching protrusion formed on the latch member. When the pivot unit is disposed at the unfolded position, the latch member is rotatable relative to the base unit to a latched position, where the latching protrusion engages the latching groove, thereby preventing rotation of the pivot unit to the folded position. A foldable furniture piece to which the joint assembly is applied is also disclosed.

### BACKGROUND OF THE INVENTION

1. Field of the Invention

This invention relates to a joint assembly, more particularly to a joint assembly for a foldable furniture piece.

2. Description of the Related Art

FIG. 1 illustrates a conventional foldable chair 1 that includes a seat 11, a rear leg 12, and a joint assembly 13. The joint assembly 13 includes a base unit 14 and a pivot unit 15. The base unit 14 includes a pivot portion 141, and a rod portion 142 that extends from the pivot portion 141 of the base unit and that is connected to the seat 11. The pivot unit 15 includes a plate portion 151 that is connected pivotably to the pivot portion 141 of the base unit 14, and a rod portion 152 that extends from the plate portion 151 of the pivot unit 15 and that is connected to the rear leg 12. The construction as such permits folding and unfolding of the rear leg 12.

The aforementioned conventional foldable chair 1 is disadvantageous in that, when in use, i.e., the rear leg 12 is unfolded, the rear leg 12 may be accidentally folded and hurt the user.

### SUMMARY OF THE INVENTION

Therefore, an object of the present invention is to provide a foldable furniture piece that can overcome the aforesaid drawback of the prior art.

Another object of the present invention is to provide a joint assembly that can overcome the aforesaid drawback of the prior art.

According to an aspect of the present invention, a foldable furniture piece comprises a support, a leg, and a joint assembly. The joint assembly includes a base unit, a pivot unit, and a latch unit. The base unit has a pivot portion, and a rod portion that extends from the pivot portion and that is coupled to the support. The pivot unit has a plate portion that is coupled pivotably to the pivot portion of the base unit, and a rod portion that extends from the plate portion and that is coupled to the leg. The pivot unit is rotatable relative to the base unit between a folded position, where the rod portion of the pivot unit is disposed substantially parallel to the rod portion of the base unit and where the leg is disposed substantially parallel to the support, and an unfolded position, where the rod portion of the pivot unit is disposed substantially perpendicular to the rod portion of the base unit and where the leg is disposed substantially perpendicular to the support. The latch unit includes a latch member, a latching groove, and a latching protrusion. The latch member is coupled pivotably to the pivot portion of the base unit. The latching groove is formed in one of the plate portion of the pivot unit and the latch member. The latching protrusion is formed on the other of the plate portion of the pivot unit and the latch member. When the pivot unit is disposed at the unfolded position, the latch member is rotatable relative to the base unit between a latched position, where the latching protrusion engages the latching groove, thereby preventing rotation of the pivot unit to the folded position, and an unlatched position, where the latching protrusion is disengaged from the latching groove, thereby permitting rotation of the pivot unit to the folded position.

According to another aspect of the present invention, a joint assembly comprises a base unit, a pivot unit, and a latch unit. The base unit has a pivot portion, and a rod portion that extends from the pivot portion. The pivot unit has a plate portion that is coupled pivotably to the pivot portion of the base unit, and a rod portion that extends from the plate portion. The pivot unit is rotatable relative to the base unit between a folded position, where the rod portion of the pivot unit is disposed substantially parallel to the rod portion of the base unit, and an unfolded position, where the rod portion of the pivot unit is disposed substantially perpendicular to the rod portion of the base unit. The latch unit includes a latch member, a latching groove, and a latching protrusion. The latch member is coupled pivotably to the pivot portion of the base unit. The latching groove is formed in one of the plate portion of the pivot unit and the latch member. The latching protrusion is formed on the other of the plate portion of the pivot unit and the latch member. When the pivot unit is disposed at the unfolded position, the latch member is rotatable relative to the base unit between a latched position, where the latching protrusion engages the latching groove, thereby preventing rotation of the pivot unit to the folded position, and an unlatched position, where the latching protrusion is disengaged from the latching groove, thereby permitting rotation of the pivot unit to the folded position.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic view of a conventional foldable chair;

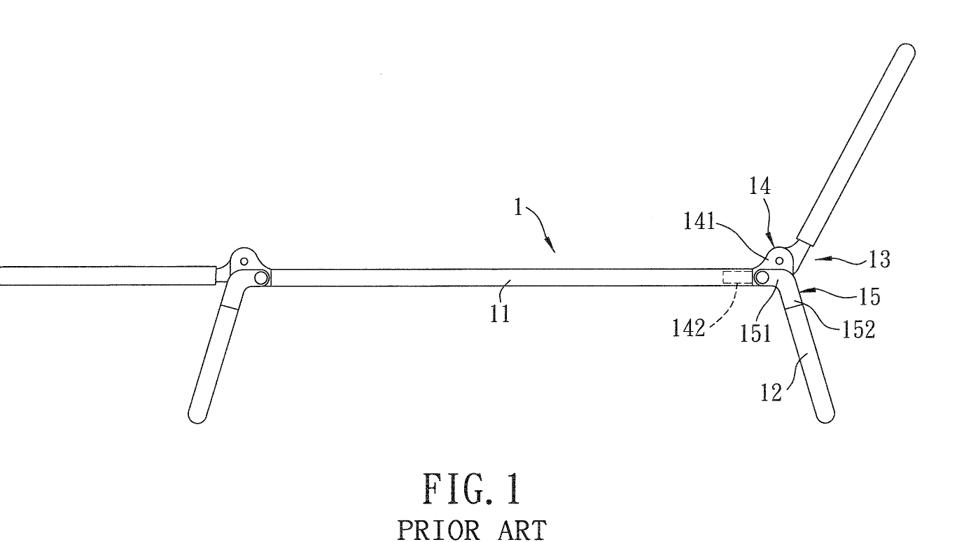

FIG. 2 is a schematic view of the preferred embodiment of a joint assembly according to this invention;

FIG. 3 is a schematic diagram illustrating the preferred embodiment when applied to a foldable chair;

FIG. 4 is a schematic diagram illustrating the preferred embodiment when disposed at the folded position; and

FIG. 5 is a schematic diagram illustrating the preferred embodiment when disposed at the latched position.

### DETAILED DESCRIPTION OF THE PREFERRED EMBODIMENT

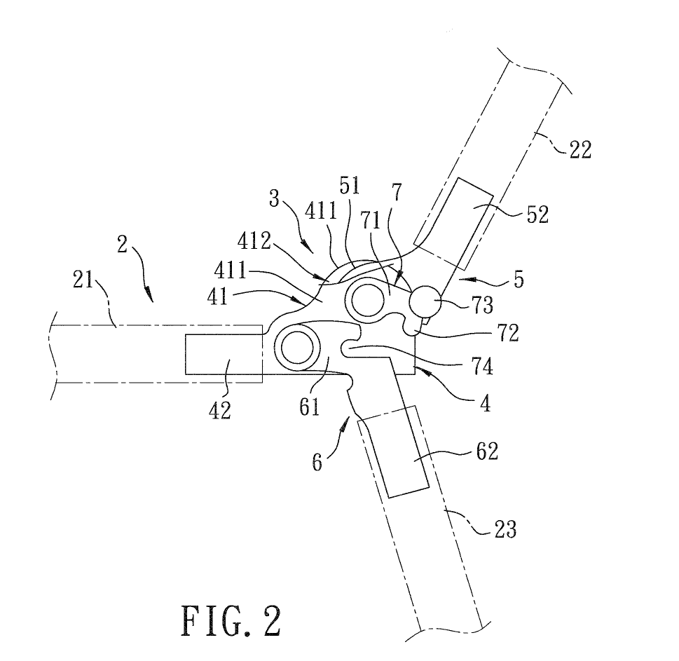

Referring to FIG. 2, the preferred embodiment of a joint assembly 3 according to this invention is shown to include a base unit 4, first and second pivot units 6, 5, and a latch unit 7.

The joint assembly 3 of this embodiment is applied to a foldable furniture piece, such as a foldable chair.

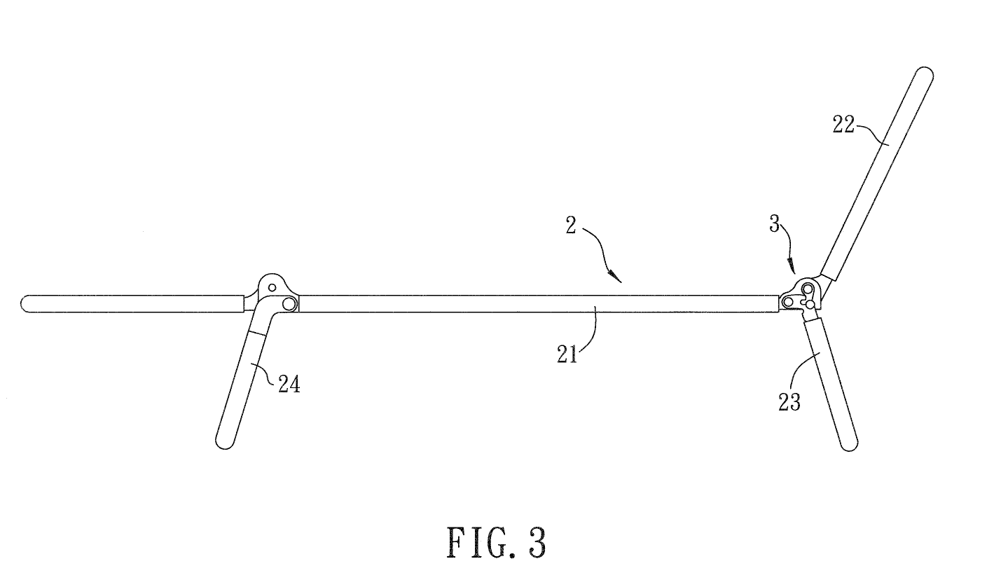

As illustrated in FIG. 3, the foldable chair 2 includes a horizontal support 21, i.e., a seat, a front leg 24 connected pivotably to a front end of the seat 21, a rear leg 23 disposed below the seat 21, and a backrest 22 disposed above the seat 21.

The joint assembly 3 interconnects the seat 21, the rear leg 23, and the backrest 22, in a manner that will be described hereinafter.

The base unit 4 has a pivot portion 41 and a rod portion 42. The pivot portion 41 of the base unit 4 includes left and right plates 411 that cooperatively define a space 412 therebetween. The rod portion 42 of the base unit 4 extends from front ends of the left and right plates 411 of the pivot portion 41 of the base unit 4 and is connected to, i.e., inserted into, a rear end of the seat 21.

The first pivot unit 6 has left and right plate portions 61 (only the left plate portion 61 is shown in FIG. 2), and a rod portion 62. Each of the left and right plate portions 61 of the first pivot unit 6 is connected pivotably to a respective one of the left and right plates 411 of the pivot portion 41 of the base unit 4. The rod portion 62 of the first pivot unit 6 extends from the left and right plate portions 61 of the first pivot unit 6 and is connected to, i.e., inserted into, an upper end of the rear leg 23.

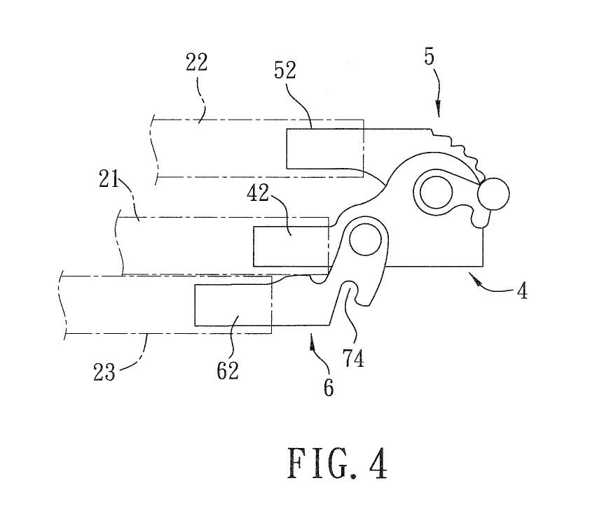

In this embodiment, the first pivot unit 6 is rotatable relative to the base unit 4 between a first folded position, where the rod portion 62 of the first pivot unit 6 is disposed substantially parallel to the rod portion 42 of the base unit 4 and where the rear leg 23 is disposed substantially parallel to the seat 21, as best shown in FIG. 4, and a first unfolded position, where the rod portion 62 of the first pivot unit 6 is disposed substantially perpendicular to the rod portion 42 of the base unit 4 and where the rear leg 23 is disposed substantially perpendicular to the seat 21, as best shown in FIG. 2.

The latch unit 7 includes a latch member 71, a latching groove 74, and a latching protrusion 72. The latch member 71 is in the form of a plate, and has a first end connected pivotably to the left plate 411 of the pivot portion 41 of the base unit 4, and a second end opposite to the first end thereof. The latching groove 74 is formed in the left plate portion 61 of the first pivot unit 6. The latching protrusion 72 is formed on the second end of the latch member 71.

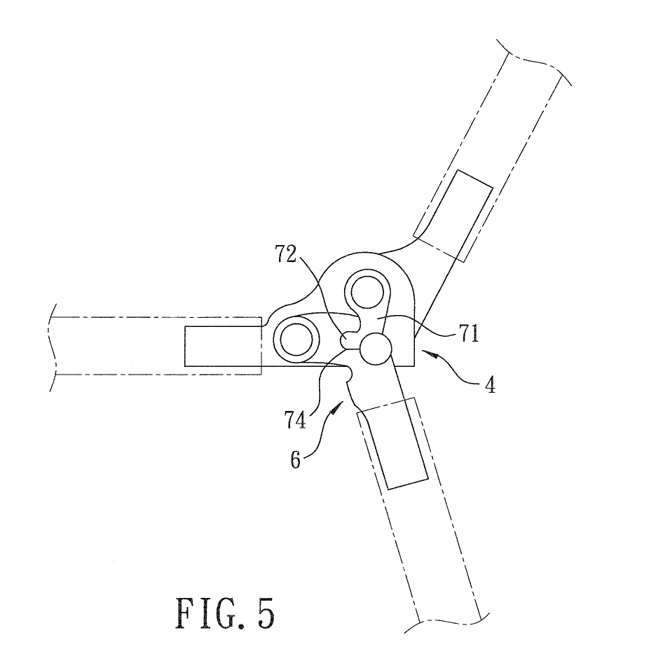

In this embodiment, when the first pivot unit 6 is disposed at the first unfolded position, the latch member 71 is rotatable relative to the base unit 4 between a latched position, where the latching protrusion 72 engages the latching groove 74, as best shown in FIG. 5, thereby preventing rotation of the first pivot unit 6 to the first folded position, and an unlatched position, where the latching protrusion 72 is disengaged from the latching groove 74, as best shown in FIG. 2, thereby permitting rotation of the first pivot unit 6 to the first folded position.

The latch unit 7 further includes a handle 73 provided on the second end of the latch member 71 for facilitating rotation of the latch member 71 between the latched and unlatched positions.

Referring back to FIG. 2, the second pivot unit 5 has a plate portion 51 and a rod portion 52. The plate portion 51 of the second pivot unit 5 extends into the space 412 in the pivot portion 41 of the base unit 4 and is connected pivotably to the left and right plates 411 of the pivot portion 41 of the base unit 4. The rod portion 52 of the second pivot unit 5 extends from the plate portion 51 of the second pivot unit 5, is disposed externally of the pivot portion 41 of the base unit 4, and is connected to, i.e., inserted into, a lower end of the backrest 22.

In this embodiment, the second pivot unit 5 is rotatable relative to the base unit 4 between a second folded position, where the rod portion 52 of the second pivot unit 5 is disposed substantially parallel to the rod portion 42 of the base unit 4 and where the backrest 22 is disposed substantially parallel to the seat 21, as best shown in FIG. 4, and a second unfolded position, where the rod portion 52 of the second pivot unit 5 is disposed substantially perpendicular to the rod portion 42 of the base unit 4 and where the backrest 22 is disposed substantially perpendicular to the seat 21, as best shown in FIG. 2.

It is noted herein that the second pivot unit 5 and the latch member 71 are rotatable relative to the base unit 4 about the same pivot axis.

The joint assembly 3 further includes a positioning unit (not shown) for retaining the second pivot unit 5 at different angles from the base unit 4 between the second folded position and the second unfolded position. Since the feature of the invention does not reside in the particular configuration of the positioning unit, a detailed description thereof will not be provided herein for the sake of brevity.

From the above description, when the foldable chair 2 is in use, i.e., the first pivot unit 6 is disposed at the first unfolded position, the latch member 71 may be simply disposed at the latched position to thereby prevent accidental folding of the rear leg 23. As such, safety of the user can be ensured.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A foldable furniture piece, comprising:
a support;
a leg; and
a joint assembly including
a base unit having a pivot portion, and a rod portion that extends from said pivot portion and that is coupled to said support,
a pivot unit having a plate portion that is coupled pivotably to said pivot portion of said base unit, and a rod portion that extends from said plate portion and that is coupled to said leg, said pivot unit being rotatable relative to said base unit between a folded position, where said rod portion of said pivot unit is disposed substantially parallel to said rod portion of said base unit and where said leg is disposed substantially parallel to said support, and an unfolded position, where said rod portion of said pivot unit is disposed substantially perpendicular to said rod portion of said base unit and where said leg is disposed substantially perpendicular to said support, and
a latch unit including a latch member coupled pivotably to said pivot portion of said base unit, a latching groove formed in one of said plate portion of said pivot unit and said latch member, and a latching protrusion formed on the other of said plate portion of said pivot unit and said latch member,
wherein when said pivot unit is disposed at the unfolded position, said latch member is rotatable relative to said base unit between a latched position, where said latching protrusion engages said latching groove, thereby preventing rotation of said pivot unit to the folded position, and an unlatched position, where said latching protrusion is disengaged from said latching groove, thereby permitting rotation of said pivot unit to the folded position.

2. The foldable furniture piece as claimed in claim 1, wherein said latch unit further includes a handle provided on said latch member for facilitating rotation of said latch member between the latched and unlatched positions.

3. The foldable furniture piece as claimed in claim 1, further comprising a backrest,
said pivot portion of said base unit including a pair of plates that cooperatively define a space therebetween,
said joint assembly further including a second pivot unit having a plate portion that extends into said space in said pivot portion of said base unit and that is coupled pivotably to said plates of said pivot portion of said base unit, and a rod portion that extends from said plate portion of said second pivot unit, that is disposed externally of said pivot portion of said base unit, and that is coupled to said backrest.

4. The foldable furniture piece as claimed in claim 3, wherein said second pivot unit and said latch member are rotatable relative to said base unit about the same pivot axis.

5. The foldable furniture piece as claimed in claim 1, wherein said latch member is in the form of a plate.

6. A joint assembly, comprising:
a base unit having a pivot portion, and a rod portion that extends from said pivot portion;
a pivot unit having a plate portion that is coupled pivotably to said pivot portion of said base unit, and a rod portion that extends from said plate portion, said pivot unit being rotatable relative to said base unit between a folded position, where said rod portion of said pivot unit is disposed substantially parallel to said rod portion of said base unit, and an unfolded position, where said rod portion of said pivot unit is disposed substantially perpendicular to said rod portion of said base unit; and
a latch unit including a latch member coupled pivotably to said pivot portion of said base unit, a latching groove formed in one of said plate portion of said pivot unit and said latch member, and a latching protrusion formed on the other of said plate portion of said pivot unit and said latch member,
wherein when said pivot unit is disposed at the unfolded position, said latch member is rotatable relative to said base unit between a latched position, where said latching protrusion engages said latching groove, thereby preventing rotation of said pivot unit to the folded position, and an unlatched position, where said latching protrusion is disengaged from said latching groove, thereby permitting rotation of said pivot unit to the folded position.

7. The joint assembly as claimed in claim 6, wherein said latch unit further includes a handle provided on said latch member for facilitating rotation of said latch member between the latched and unlatched positions.

8. The joint assembly as claimed in claim 6, wherein said pivot portion of said base unit includes a pair of plates that cooperatively define a space therebetween, said joint assembly further comprising a second pivot unit having a plate portion that extends into said space in said pivot portion of said base unit and that is coupled pivotably to said plates of said pivot portion of said base unit, and a rod portion that extends from said plate portion of said second pivot unit and that is disposed externally of said pivot portion of said base unit.

9. The joint assembly as claimed in claim 8, wherein said second pivot unit and said latch member are rotatable relative to said base unit about the same pivot axis.

10. The joint assembly as claimed in claim 6, wherein said latch member is in the form of a plate.
